(19) United States
(12) Patent Application Publication
(10) Pub. No.: US 2013/0342687 A1
(43) Pub. Date: Dec. 26, 2013

(54) SYSTEM AND METHOD FOR DEFINING AN AREA OF INTEREST OF AN IMAGING OCCUPANCY SENSOR

(71) Applicant: Richard Leinen, Wilsonville, OR (US)

(72) Inventor: Richard Leinen, Wilsonville, OR (US)

(73) Assignee: LEVITON MANUFACTURING COMPANY, INC., Melville, NY (US)

(21) Appl. No.: 13/530,814

(22) Filed: Jun. 22, 2012

(51) Int. Cl. H04N 7/18

(52) U.S. Cl. 348/143; 348/E07.085

(57) ABSTRACT

A system and method are disclosed for adjusting a field of view of an image sensor to correspond to an outer dimension of a monitored space. The image sensor may be part of an occupancy sensor configured to sense movement within the space and to adjust lighting in the area accordingly. The occupancy sensor includes an image sensor coupled to a processor, an input device for adjusting the field of view in a plurality of dimensions. By knowing the height at which the sensor will be mounted above the space, a user can employ the input device to adjust the field of view of the sensor so that when the sensor is mounted the field of view corresponds to at least one outer dimension of the monitored space. Other embodiments are disclosed and claimed.

### FIELD OF THE DISCLOSURE

The present disclosure relates generally to occupancy sensing systems, and more particularly to an improved system and method for defining an area of interest of an imaging occupancy sensor.

### BACKGROUND OF THE DISCLOSURE

Occupancy sensors are designed to save energy by detecting the presence of a moving object in an area of coverage and switching a light source on and off depending upon the presence of the moving object. For example, when a moving object is detected within the area of coverage, the light source is turned on. Alternatively, when motion is not detected indicating that the area of coverage is not occupied, the light source is turned off after a predetermined period of time. Occupancy sensors thus facilitate electrical energy savings by automating the functions of a light switch or an electrical outlet.

Typical occupancy sensor designs can utilize one or more sensing technologies to sense motion, such as ultrasonic, passive infrared (PIR), and audible sound sensor technologies, among others. PIR and ultrasonic sensors work by detecting motion within their field of view, while audible sound sensors report the intensity of sound received at a microphone. These sensors are often of limited and/or uncertain coverage. For example, PIR and ultrasonic sensors may detect motion outside the boundaries of the space to be monitored, while sound sensors may be unable to distinguish between moderate sounds within the space and loud sounds from outside the space. In particular, a PIR sensor's area of sensitivity may “spill” into places where detected motion is not desired to affect the controlled device.

As an alternative to PIR, ultrasonic and audible sound sensor technologies, imaging occupancy sensors can be used to monitor occupancy of a space. Such imaging occupancy sensor can include infrared or visible-light cameras that detect occupancy directly, rather than by detecting movements or noises. Such optical sensing technologies can provide improved occupant detection accuracy. Still, optical sensing technologies must be carefully calibrated so they will detect occupancy only in the monitored space, and not in adjacent areas.

Thus, there is a need for an improved system and method for defining/setting an area of interest for monitoring using an imaging occupancy sensor. The system and method should enable simple definition/setting of the area of interest such that upon installation of the sensor in a desired location, the sensor will monitor only the predefined area of interest and will not return “occupied” signals from people or objects located outside the predefined area of interest.

### SUMMARY OF THE DISCLOSURE

An occupancy sensor is disclosed. The sensor may include an image sensor, a processor coupled to the image sensor for receiving sensor signals therefrom and for outputting a signal representative of an occupied condition of a monitored space, and an input device for adjusting of a field of view of the image sensor to conform the field of view with a predetermined portion of the monitored space. The occupancy sensor may also include a load controller for receiving the signal representative of an occupied condition of the monitored space and for controlling electrical power to a load in response thereto. The input device may be configured to adjust first and second dimensions of the field of view of the image sensor. In some embodiments the input device comprises a plurality of predetermined set points corresponding to predetermined dimensions of the field of view of the image sensor.

The occupancy sensor may also include a memory associated with the processor, the memory for storing the sensor signals and the signals representative of an occupied condition of a monitored space. In one embodiment, the adjusted field of view of the image sensor comprises a geometric shape. In other embodiments, the image sensor is a visible-light camera or an infrared camera.

An occupancy sensor is disclosed, comprising an image sensor, a processor coupled to the image sensor for receiving a signal therefrom and for outputting a signal representative of an occupied condition of a monitored space based on the signal received from the image sensor, and an input device for adjusting of a field of view of the image sensor to correspond to a portion of the monitored space. The input device may have a plurality of predetermined adjustment levels, the plurality of predetermined adjustment levels associated with a predetermined plurality of field of view dimensions of the image sensor.

The occupancy sensor may also include a load controller for receiving the signal representative of an occupied condition of the monitored space and for controlling electrical power to a load in response thereto. The load controller may be configured to control electrical power to at least one light associated with the monitored space. The input device may include a plurality of predetermined set points corresponding to predetermined long and short dimensions of the field of view of the image sensor.

The occupancy sensor may include a memory associated with the processor, the memory for storing the sensor signals and the signals representative of an occupied condition of a monitored space. The adjusted field of view of the image sensor may be a geometric shape. The image sensor may be a visible-light camera or an infrared camera.

A method is disclosed for setting an image sensor for monitoring occupancy of a space. The method may comprise: at the imaging sensor, actuating an input device to adjust a field of view of the image sensor, where adjusting the field of view of the imaging sensor comprises adjusting the field of view to correspond to at least one dimension of the space. In some embodiments, actuating an input device may comprise adjusting at least one of a long dimension of the field of view and a short dimension of the field of view. The method may also include, prior to actuating the input device, determining a mounting height of the image sensor, where the mounting height comprising a distance measured from a bottom surface of the space and a mounting location of the image sensor, and determining an initial field of view of the image sensor.

The method may also include determining first and second outer dimensions of the space, wherein adjusting the field of view of the imaging sensor comprises adjusting the field of view to correspond with the first and second outer dimensions. In some embodiments, the method includes mounting the image sensor at a mounting location positioned at a mounting height above the space, where adjusting the field of view of the imaging sensor compensates for the mounting height to adjust the field of view to correspond to the at least one dimension of the space. In other embodiments, adjusting the field of view of the image sensor may include obtaining at least one characteristic of the image sensor from a label associated with the image sensor.

### BRIEF DESCRIPTION OF THE DRAWINGS

By way of example, a specific embodiment of the disclosed device will now be described, with reference to the accompanying drawings, in which:

FIG. 1 is a schematic diagram of an exemplary image sensing system position to monitor an outdoor area;

FIG. 2 is a schematic diagram of an exemplary embodiment of the image sensing system of FIG. 1;

FIG. 3 is an illustration of an exemplary coverage area using the image sensing system of FIGS. 1 and 2; and

FIG. 4 is a flow chart illustrating an exemplary method of operating the image sensing system of FIGS. 1 and 2.

### DETAILED DESCRIPTION

A system and method are disclosed for monitoring occupancy of outdoor spaces using image sensing techniques. In particular, a system and method for monitoring occupancy of outdoor spaces such as parking lots is disclosed. As will be appreciated, such outdoor spaces can be susceptible to detection of motion outside the boundaries of the space to be monitored, since such boundaries may not be defined by walls. Thus, for a variety of reasons standard occupancy sensing technologies (e.g., PIR, ultrasonic, audible) may not provide a desired level of reliability for outdoor space occupancy sensing, and can result in “false on” signals when movement is detected in areas adjacent to the monitored space.

In some embodiments an image sensor may be configured to monitor a particular predefined outdoor space in a manner that facilitates reliable occupancy detection only within the area of interest and which ignores objects and/or movement outside the area of interest. For example, when the sensor is used to monitor a parking lot, it is desirable that the lot lights be turned on only when a person or car enters the lot. It is similarly desirable that the lot lights not be turned on when a person is walking on an adjacent sidewalk, or a car is moving along an adjacent street.

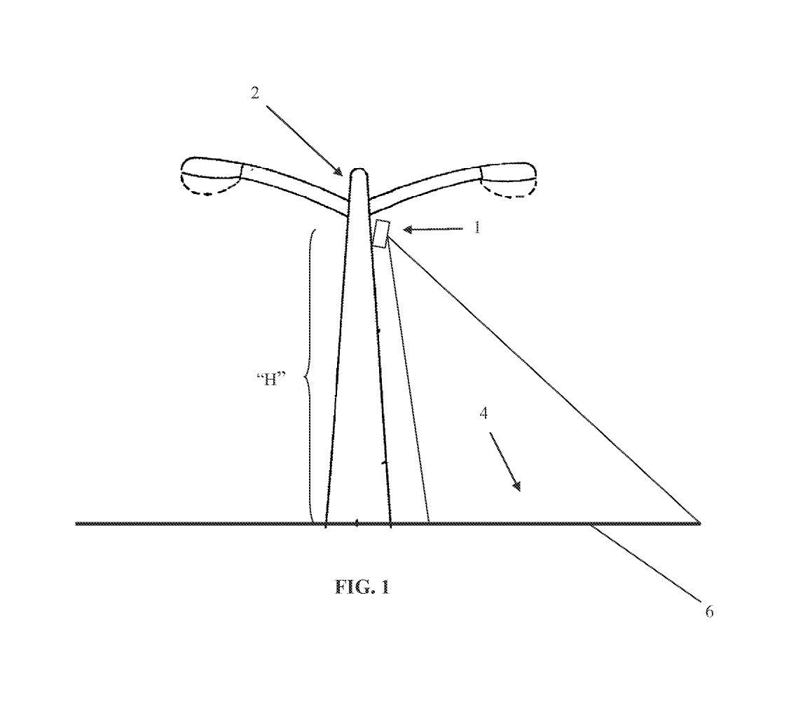

FIG. 1 shows an exemplary outdoor application in which an occupancy sensor 1 is mounted on an upper region of a light pole 2 so that the sensor may monitor a portion 4 of a parking lot 6 illuminated by the light. Although a single sensor 1 is illustrated, in some implementations multiple sensors 1 may be used in actual implementation to cover an entire monitored area, such as a large parking lot.

In addition, it will be appreciated that the disclosed occupancy sensor 1 is not limited to light pole installations, and thus it may be mounted on any of a variety of surfaces including walls and ceilings. Examples of appropriate mounting arrangements include wall-mounted sensors positioned to monitor alleys, driveways, enclosed courtyards, and the like. Ceiling mounted sensors could be used, for example, in outdoor parking garage applications.

A benefit of employing image sensing technologies for use as occupancy sensors is that they can be adjusted so that the “area of interest” covered by the image sensor can be precisely set. As will be appreciated, however, the height “H” at which the occupancy sensor 1 is mounted can make it difficult to set or otherwise adjust the area of interest of the sensor after the sensor has been mounted to the light pole 2. Thus, it may not be practical to install the sensor, and then to adjust the area of interest by having another installer walk the perimeter of the monitored space. It would, therefore, be desirable to set the area of interest of the image sensor before mounting the sensor on the pole (or wall).

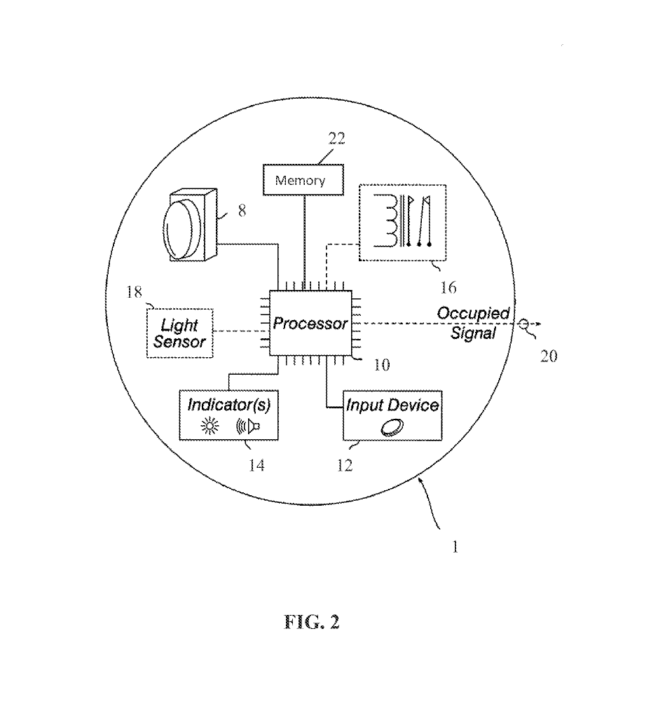

Referring to FIG. 2, a schematic of an exemplary occupancy sensor 1 according to the disclosure is shown. The occupancy sensor 1 may include an image sensor 8 coupled to a processor 10 that is programmed to identify a moving object in an image captured by the image sensor. In some embodiments, the processor 10 may be programmed to implement a sequence of actions upon sensing the presence of a moving object. To define an area of interest, the image sensor 8 and processor 10 may be arranged and programmed to receive an input from an installer via a dip switch, button, dial or other physical control. Based on this input, a field of view of the image sensor 8 can be adjusted to conform to a predetermined area of interest. In one non-limiting embodiment, the area of interest is a portion of an outdoor parking lot.

The image sensor 8 may be a visible-light or infrared (IR) camera, while the processor 10 may be a microcontroller or digital signal processor (DSP). The image sensor 8 and the processor 10 may be placed in a housing similar to that of existing occupancy sensors. The occupancy sensor 1 may also include an input device 12 such as a dip switch, button, dial or other physical control, to initiate adjustment of the field of view of the image sensor 8. By adjusting the field of view of the image sensor 8 to closely conform to the outer boundaries of a monitored space, during normal operation “false-on” errors can be eliminated or reduced when a person or object moves near the space, but does not enter the space. For example, where the monitored space is a parking lot, the image sensor 8 may not operate to turn lot lighting on where a car is moving in the street adjacent to the lot. When the car turns into the lot, however, the image sensor 8 may then operate to turn the lot lighting on.

The occupancy sensor 1 may include one or more indicators 14, such as a light-emitting diode (LED), liquid crystal display (LCD), electronic beeper, or the like to provide feedback to the person performing the field of view adjustment operation. For example, an LCD display may be used to show the installer the selected dimensions of the image sensor's field of view. Alternatively, one or more beeps or light flashes may signal to the installer that a particularly sized field of view has been selected.

The occupancy sensor 1 may include a load controller such as a relay 16 for controlling electrical power to a load, or a light sensor 18 for measuring the ambient light in the vicinity of the occupancy sensor and modifying its operational logic based thereon. Some occupancy sensors may emit an “occupied” signal 20 to alert one or more associated system components that the occupancy sensor has detected certain events or conditions. For example, a history of occupancy events can be stored in local memory 22 associated with the processor 10. This information can be used to determine, for example, the number of cars in a parking lot during a particular time of day, or the typical length of time a car stays in the lot. This and other information can be correlated with entry/exit information regarding cars or people to confirm that the image sensor is operating properly. In some embodiments, the sensor 1 may be coupled to a private or public network to allow occupancy information to be transferred to a remote computer and/or facility. In some embodiments occupancy information may be sent via the Internet to a web page to enable remote monitoring of the associated space. A building manager, lot manager, or other authorized individual or agency may monitor this information to enable easy access to occupancy data.

As previously noted, the disclosed system may employ known characteristics of the image sensor 8 to enable setting of a predetermined area of interest prior to mounting the sensor on the light pole (or wall or ceiling, as the case may be). For example, the lens of the image sensor 8 may have a known the focal length, while the size of the imager may also be known. As such, the area that the image sensor 8 can “see” for a particular distance can be calculated. For example, given an image sensor with known specifications it may be determined that when focused on a plane 25-feet away, the image detection region may measure 30-feet by 40-feet. If that distance were doubled (to 50-feet), the size of the image detection region would also double. Since the sensor installer will typically know what the mounting height is, and will also know the dimensions of the area of interest (i.e., the area to be monitored), device controls (input device 12) can be employed to adjust the field of view of the image sensor 8 in two dimensions to approximate the area to be monitored.

In one exemplary embodiment, the mounting height “H” of the occupancy sensor 1 may be 25-feet, while the desired area of interest may be 20 feet square. If the long dimension of the image sensor 8 is 40-feet, the installer can simply adjust the control 12 relating to that dimension to reduce the sensor's field of view by half, thus resulting in a long dimension of 20 feet. If the short dimension of the image sensor 8 is 30-feet, the installer can adjust the control 12 relating to that dimension to reduce the field of view by two thirds, thus resulting in a short dimension of 20 feet. Such adjustments can be performed before the installer arrives at the installation location, or before the sensor 1 is installed on the pole 2 or wall.

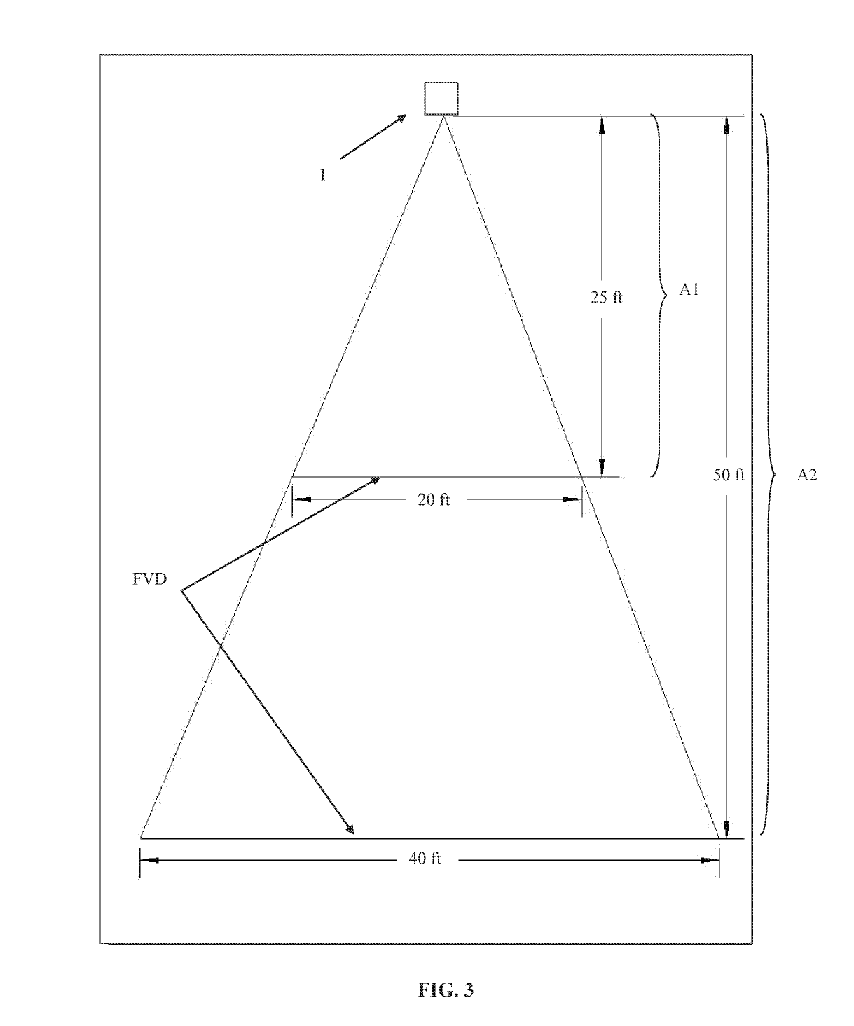

FIG. 3 shows how an area of interest of the image sensor 8 may be adjusted to fit a desired area of interest. Thus, in a first configuration, the field of view of the image sensor 8 may be adjusted to monitor a desired area of interest when the sensor 8 is mounted at a first height “A1.” In the illustrated embodiment, “A1” is about 25 feet, which results in a field of view having a first view dimension of about 20 feet. The same image sensor 8 when mounted at a second height “A2” that is twice the height of “A1” may result in a field of view having a first view dimension of about 40 feet. In the illustrated embodiment, “A2” is about 50 feet. Although not shown, it will be appreciated that the sensor 8 will also have a second view dimension oriented perpendicular to the first view dimension, and that the second dimension may change similarly to that of the first dimension based on the height of the sensor above the area to be monitored. This illustration shows that the image sensor's field of view is proportional, and thus it can be predetermined based on a given vertical distance between the sensor and the area to be monitored. This predetermined “natural” field of view information can then be used, along with a known actual mounting height of the sensor 8, to adjust the sensor 8 to have a desired predetermined field of view (for example, one that is smaller in a first and/or second view dimension than a “natural” field of view of the sensor 8) prior to mounting the sensor at a desired mounting location. The desired predetermined field of view may thus be customized to mimic the actual boundaries of the area to be monitored.

The occupancy sensor 1 may be provided with a variety of incremental presets so that the control 12 can be used to finely adjust the field of the view of the image sensor 8 to cover a desired area of interest. In one embodiment, a simple grid diagram or table may be included in the owner's manual provided with the occupancy sensor 1. Alternatively, a label on the sensor 1 could provide the dimensional characteristics of the sensor so the setting can be accomplished before the sensor is mounted.

In further embodiments, a more complex method may be employed to enable the predefined area of interest to be contained within an ellipse or other geometric shape. Similar dimensional adjustments could then be made. For example, sensors could be manufactured with a predefined viewing shape such as circular, elliptical or the like. Alternatively, sensors could be provided with a selector such as a DIP switch that would enable the user to select between one of a variety of field of view shapes (e.g., rectangular, triangular, circular, elliptical).

It will be appreciated that although the illustrated embodiments show a single image sensor 8 for use in monitoring a particular area, it is contemplated that monitoring of a typical parking lot would involve the use of multiple overlapping image sensors 8. For example, in some embodiments, each of the multiple overlapping image sensors 8 would be adjusted to have different field of view dimensions so as to cover a desired segment of the parking lot. Different combinations of sensor mounting heights and sensor fields of view could be used to provide efficient coverage of oddly-shaped lots and garage spaces.

Thus arranged, the disclosed system and method enable an area of interest of an image sensor to be defined by using simple geometric analysis and settings so that the sensor can be preset to monitor a predetermined area prior to installing the sensor on a light pole or wall associated with a monitored space.

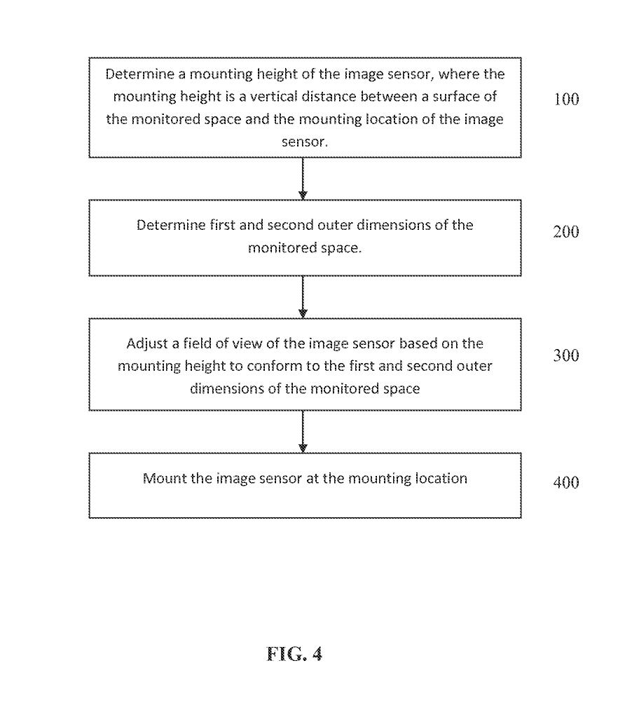

An exemplary method of using the disclosed system 1 will now be described in relation to FIG. 4. At step 100, a mounting height of the image sensor is determined, wherein the mounting height is a vertical distance between a surface of the monitored space and the mounting location of the image sensor. At step 200, at least first and second outer dimensions of the monitored space are determined. At step 300, a field of view of the image sensor is adjusted, based on the mounting height, to conform to the first and second outer dimensions of the monitored space. In some embodiments, adjusting the field of view comprises actuating an input device associated with the image sensor. Actuating the input device may include adjusting at least one of a long dimension of the field of view and a short dimension of the field of view. At step 400, the image sensor is mounted at a mounting location.

Some of the inventive principles of the disclosure relate to techniques for occupancy sensing, in particular, for sensing the presence or motion of a person or a moving object in an area of interest. In one embodiment, lighting levels can be adjusted in or about the area of interest responsive to sensing the person or moving object. In another embodiment, a security alarm can be triggered responsive to sensing the person or moving object.

Some embodiments of the disclosed device may be implemented, for example, using a storage medium, a computer-readable medium or an article of manufacture which may store an instruction or a set of instructions that, if executed by a machine (i.e., processor or microcontroller), may cause the machine to perform a method and/or operations in accordance with embodiments of the disclosure. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision additional modifications, features, and advantages within the scope and spirit of the claims appended hereto.

1. An occupancy sensor, comprising:
an image sensor;
a processor coupled to the image sensor for receiving sensor signals therefrom and for outputting a signal representative of an occupied condition of a monitored space; and
an input device for adjusting of a field of view of the image sensor to conform the field of view with a predetermined portion of the monitored space.

2. The occupancy sensor of claim 1, further comprising a load controller for receiving the signal representative of an occupied condition of the monitored space and for controlling electrical power to a load in response thereto.

3. The occupancy sensor of claim 1, wherein the input device is configured to adjust first and second dimensions of the field of view of the image sensor.

4. The occupancy sensor of claim 1, wherein the input device comprises a plurality of predetermined set points corresponding to predetermined dimensions of the field of view of the image sensor.

5. The occupancy sensor of claim 1, further comprising a memory associated with the processor, the memory for storing the sensor signals and the signals representative of an occupied condition of a monitored space.

6. The occupancy sensor of claim 1, wherein the adjusted field of view of the image sensor comprises a geometric shape.

7. The occupancy sensor of claim 1, wherein the image sensor is a visible-light camera or an infrared camera.

8. An occupancy sensor, comprising:
an image sensor;
a processor coupled to the image sensor for receiving a signal therefrom and for outputting a signal representative of an occupied condition of a monitored space based on the signal received from the image sensor; and
an input device for adjusting of a field of view of the image sensor to correspond to a portion of the monitored space, the input device having a plurality of predetermined adjustment levels, the plurality of predetermined adjustment levels associated with a predetermined plurality of field of view dimensions of the image sensor.

9. The occupancy sensor of claim 8, further comprising a load controller for receiving the signal representative of an occupied condition of the monitored space and for controlling electrical power to a load in response thereto.

10. The occupancy sensor of claim 9, wherein the load controller is configured to control electrical power to at least one light associated with the monitored space.

11. The occupancy sensor of claim 8, wherein the input device comprises a plurality of predetermined set points corresponding to predetermined long and short dimensions of the field of view of the image sensor.

12. The occupancy sensor of claim 8, further comprising a memory associated with the processor, the memory for storing the sensor signals and the signals representative of an occupied condition of a monitored space.

13. The occupancy sensor of claim 8, wherein the adjusted field of view of the image sensor comprises a geometric shape.

14. The occupancy sensor of claim 8, wherein the image sensor is a visible-light camera or an infrared camera.

15. A method for setting an image sensor for monitoring occupancy of a space, the method comprising:
at the imaging sensor, actuating an input device to adjust a field of view of the image sensor;
wherein adjusting the field of view of the imaging sensor comprises adjusting the field of view to correspond to at least one dimension of the space.

16. The method of claim 15, wherein actuating an input device comprises adjusting at least one of a long dimension of the field of view and a short dimension of the field of view.

17. The method of claim 16, further comprising, prior to actuating the input device:
determining a mounting height of the image sensor, the mounting height comprising a distance measured from a bottom surface of the space and a mounting location of the image sensor; and
determining an initial field of view of the image sensor.

18. The method of claim 17, further comprising determining first and second outer dimensions of the space, wherein adjusting the field of view of the imaging sensor comprises adjusting the field of view to correspond with the first and second outer dimensions.

19. The method of claim 17, further comprising mounting the image sensor at a mounting location positioned at a mounting height above the space, wherein adjusting the field of view of the imaging sensor compensates for the mounting height to adjust the field of view to correspond to the at least one dimension of the space.

20. The method of claim 15, wherein adjusting the field of view of the image sensor includes obtaining at least one characteristic of the image sensor from a label associated with the image sensor.
